(19) United States
(12) Patent Application Publication
(10) Pub. No.: US 2014/0045776 A1
(43) Pub. Date: Feb. 13, 2014

(54) METHOD FOR INCREASING THE SHELF LIFE OF FOOD PRODUCTS

(71) Applicants: Emmanuelle Martin, Villeneuve d'Ascq (FR); Jean-Christophe Bogaert, Escanaffles (BE)

(72) Inventors: Emmanuelle Martin, Villeneuve d'Ascq (FR); Jean-Christophe Bogaert, Escanaffles (BE)

(73) Assignee: GALACTIC S.A., Escanaffles (BE)

(21) Appl. No.: 14/000,840

(22) PCT Filed: Jan. 20, 2012
(86) PCT No.: PCT/EP2012/050891

§ 371 Date: Oct. 17, 2013

(30) Foreign Application Priority Data
Feb. 21, 2011 (BE) 2011/0120

(51) Int. Cl. A23B 4/20

(52) U.S. Cl. CPC A23B 4/20
USPC 514/23

(57) ABSTRACT

The invention relates to a method for increasing the shelf life of meat-based or fish-based food products, while at the same time preserving an acceptable appearance thereof, by treating these products with an antibacterial (or antimicrobial) composition obtained from a fermentation liquor containing lactic acid neutralized with an alkali metal hydroxide.

### FIELD OF THE INVENTION

The invention relates to a method for increasing the shelf life of food products based on meat or fish, by adding in the matrix an antimicrobial composition obtained by direct fermentation using a non-pathogenic bacterium producing lactic acid.

### PRIOR ART

At the present time, numerous foodstuffs arrive at their “use by” date without having been consumed and this is why increasing the shelf life of these products is an important problem.

The main source of degradation of perishable foodstuffs is the grown of microorganisms (bacteria, yeasts, moulds). In the case of meat, it is generally accepted that the internal tissues of slaughtered healthy animals do not contain any bacterium at the time of slaughter. Fresh meat may on the other hand be contaminated subsequently, during cutting, mincing or slicing, by contamination external to the digestive system, by non-sterile containers or by handlers.

It is known to persons skilled in the art, as described in the patents EP 482 322, EP 1 300 085 and U.S. Pat. No. 5,192,565, that organic acids have, in most cases, antibacterial properties; however, they cannot be used in the majority of meat or fish products currently available on the market because of the final appearance that they give to the food products.

This is because, because of the reduction in pH that they cause, organic acids considerably reduce the water-retention capacity of meat or fish. The food products then obtained do not have a sufficiently presentable appearance and become unacceptable in the eyes of the consumer. Furthermore, when cooked products are prepared, the loss of water reduces the cooking efficiency, thereby giving rise to a loss for the food industry on an economic level.

In order to remedy this problem, it has already been proposed to use organic acid salts having a neutral pH, which are preferred for the majority of applications in meat or fish matrices.

This is because organic acid salts such as for example sodium lactate or potassium lactate (with a neutral pH) are normally used in various sectors of the food industry and allowed by legislation (eg: EU Directive 95/2 CE: “quantum satis”, the main outlet being the meat industry. They have a bacteriostatic effect and therefore act as a preservative by inhibiting the growth of microorganisms and particularly bacteria.

However, their efficacy still remains limited since the dose to be used is sufficiently low not to modify the organoleptic properties (particularly the taste) of the product.

Still from the same point of view, it has already been proposed to use other organic acid salts as described in the U.S. Pat. No. 6,387,427, which describes a method for preserving food products comprising the addition of a acetate salts; however, the concentrations of acetic acid salt used that afford an improvement in the preservation have a considerable impact on the taste of the product. This is because the dose used is 0.5% of a product containing 72% potassium acetate; however, it is known that a dose greater than 0.1% of pure potassium acetate generally confers an acetic taste on the product. Potassium acetate is moreover considered to be a flavouring by the FDA (Foot and Drug Administration) (“Sec. 172.515 Synthetic flavoring substances and adjuvants”).

There therefore exists a need for a method for increasing the shelf life of food products that does not have a negative impact on the taste of the products obtained or their texture and appearance.

### BRIEF DESCRIPTION OF THE INVENTION

The invention relates to a method for increasing the shelf life of food products based on meat or fish while keeping an acceptable appearance for them, by treating these products with an antibacterial (or antimicrobial) composition obtained from a fermentation liquor containing lactic acid neutralised by means of an alkali metal hydroxide.

### DETAILED DESCRIPTION OF THE INTENTION

The applicant has now found unexpectedly that the shelf life of food products based on meat or fish could be significantly increased by treating these products with an antibacterial composition obtained from a lactic fermentation liquor obtained by means of a non-pathogenic bacterium producing lactic acid and neutralised by means of an alkali metal hydroxide.

According to the method of the invention, by using a lactic fermentation liquor obtained by fermentation using a non-pathogenic bacterium producing lactic acid and neutralising it with alkali metal hydroxide, such as sodium or potassium, an antimicrobial composition is produced that comprises mainly lactic acid salts (in addition to the other components of the fermentation liquor). Potassium lactate will be taken as an example from the description of the invention and henceforth referred to as “fermentate” since it is obtained by direction fermentation of a sugar without intermediate steps. If necessary, supplementary purification steps can be envisaged such as for example passage over ion, anion, or cation exchange resins and/or passing over activated carbon and/or any purification technique known to persons skilled in the art, provided that these steps in no way affect the antimicrobial properties of the end product.

As the fermentate used in the method of the present invention must meet the criteria on impurities laid down by legislation on food products, in particular European and American legislation, which require in particular that they be “safe”, that is to say “without danger to health”, the applicant found that the antimicrobial composition used in the method of the invention could come from a fermentate obtained by fermentation of a sugar by various non-pathogenic strains, alone or in combination, such as for example strains of the Sporolactobacillus, Brevibacillus or Bacillus (coagulans or smithii) genera, making it possible to obtain a main salt (total concentration: 30%-80%), residual impurities (sum of the elements other than the lactates representing a total percentage >1% of the dry matter) and water. This is because the Bacillus genus has the QSP (Qualified Presumption of Safety) status attributed by the European Food Safety Authority (EFSA), in the context of use thereof in human and animal food with the special qualification of absence of food toxin, surfactant activity and enterotoxin activity.

Moreover, the patent WO 92/21 246 claims the use of Sporolactobacillus as a probiotic agent.

The fermentate of the invention contains generally and non-exhaustively the following elements: a majority of lactic acid salts and a minority, not exceeding 5%, of each of the salts of acetic, succinic, propionic, malic, fumaric, citric, pyruvic and formic acids, as well as ethanol and sugars.

By way of example of composition of the fermentate, the following in particular can be mentioned: a concentration of 73% lactate, 5% potassium, 8% sodium, 3% acetate, 2% malate, 0.5% citrate, 0.5% pyruvate, 1% ethanol and 7% sugar.

Elements of various natures such as, non-exhaustively, peptides, proteins, nucleotides, saccharides or polysaccharides, and other non-identified compounds resulting from the fermentation, are also present in small but non-zero quantities.

It should be noted that the sodium and potassium lactates generally sold are not obtained by the direct fermentation of carbohydrates neutralised by the corresponding sodium and potassium hydroxides but indeed starting from lactic acid with all traces of impurities previously removed by multiple purification steps (ion exchange resins, activated carbons, distillation or any other techniques well known to persons skilled in the art).

The food products, meat or fish, are then put in contact with a quantity of “fermentate” with a view to acting on the shelf life of these products. Generally these quantities are between 2% and 4.8% of a fermentate having a main salt concentration of 40%. However, quantities as low as 1.5% (of a fermentate having a main salt concentration of 40%) may be used without affecting the efficacy of the method of the invention.

Other details and particularities of the invention, given below by way of non-limitative examples, will emerge from the description as a few possible embodiments thereof.

### Example 1

The usual formulation of a minced meat was prepared with the following ingredients:

| Ingredient | % |
|---|---|
| Pork | 69.23% |
| Fat | 23.07% |
| Water | 6.00% |
| Salt | 1.00% |
| Sugar | 0.50% |
| Pepper | 0.20% |
| Total | 100% |

Preservatives were added to this basic formulation, the maximum percentage being 4% (of a fermentate having a main-salt concentration of 40%) compared with the whole of the meat-based food product.

The minced meats are prepared according to the following procedure:

a) Preparing of the meat: the meat and fat are cut into small pieces and minced using a mincer having a 4 mm mincing grille. The meat, fat and other ingredients are then disposed by means of a mixer of the Kenwood type having a type K stirring blade. Operate the stirring for 30 seconds (minimum power).

b) Sampling: the product thus obtained is divided into 100 g samples and placed in plastic bags.

c) Storage: the products obtained are packaged in stretch film and stored at a temperature of 4° C.±1° C. for 10 days.

Twice a week, the pH, the activity of the water (Aw) and total number of aerobic bacteria were evaluated on the samples.

The shelf life of the product prepared without a preservative (reference) was compared with that of the product containing standard potassium lactate—Galoflow PL (Galactic SA) and that of the product containing the fermentate obtained by sugar fermentation by Bacillus coagulans spp. In these two cases, the main-salt concentration was adjusted to 40% before incorporation in the meat product to the extent of 4% by weight. The results are set out in graph 1.

It will be noted that the reference has a shelf life of 5 days (defined as being the time at which the concentration of aerobic germs reaches log 6 cfu/g) whereas the product containing standard potassium lactate has its shelf life extended by one day. As for the product containing the “fermentate”, its shelf life is extended by 5 days compared with the reference, which can be explained by the presence of various compounds such as, non-exhaustively, peptides, proteins, nucleotides, saccharides or polysaccharides, and other unidentified compounds resulting from the fermentation.

### Example 2

The usual formulation of a minced meat was prepared with the same compositions as in example 1.

Potassium acetate (main-salt concentration=60%) was added to this formulation based on minced meat, various concentrations with respect to the whole of the meat-based food product were tested in order to determine the acceptable dosage for avoiding any impact on the taste of the end product. Taste tests were carried out by a panel of ten experienced testers. The results are set out in table 1.

TABLE 1
Impact of the potassium acetate concentration
on the taste.

| Potassium acetate concentration (%) | Taste |
|---|---|
| 0.05 | 0 |
| 0.1 | 1 |
| 0.15 | 1 |
| 0.2 | 1 |
| 0.25 | 1 |

0 = no change in taste compared with a minced meat not containing potassium acetate;
1 = change in taste compared with a minced meat not containing potassium acetate.

The same test is carried out with potassium lactate (main-salt concentration 60%), and the results are set out in table 2.

TABLE 2
Impact of the concentration of commercially
available potassium lactate—Galaflow PL (Galactic SA)—
(main-salt concentration = 60%) on the taste

| Potassium lactate concentration (%) | Taste |
|---|---|
| 1 | 0 |
| 2 | 0 |
| 3 | 1 |

0 = no change in taste compared with a minced meat not containing potassium lactate;
1 = change in taste compared with a minced meat not containing potassium lactate.

The various doses used during these tests are the typical doses used in industrial meat matrices.

It should be noted that, as from 0.1% potassium acetate, an acidic taste is observed in the sample.

The maximum concentration before obtaining an impact on the taste is chosen, namely 0.05% for potassium acetate and 2% for potassium lactate. An identical test to that in example 1 is then performed. The results are set out in graph 2.

It will be noted that potassium lactate at a concentration not impacting on taste has a preservative effect superior to that of potassium acetate at a concentration not impacting on the taste. Likewise, it will be observed that the best effect on the preservation of the meat matrix tested is obtained with the incorporation of the fermentate issuing from the invention, also incorporated at a concentration not impacting on the taste of the meat product.

### Example 3

The usual formulation of a minced meat was prepared with the same composition as for example 1.

Potassium lactate containing a main-salt concentration of 60% was incorporated in this formulation based on minced meat, various concentrations with respect to the whole of the meat-based food product were tested in order to demonstrate the efficacy as a function of concentration.

The minced meat is prepared according to the following procedure:

a) Preparation of the meat: the meat and fat are cut into small pieces and minced using a mincer having a 4 mm mincing grille. The meat, fat and other ingredients are then disposed by means of a mixer of the Kenwood type having a type K stirring blade. Operate the stirring for 30 seconds (minimum power).

b) Sampling: the product thus obtained is divided into 100 g samples and placed in plastic bags.

c) Storage: the products obtained are packaged in stretch film and stored at a temperature of 4° C.±1° C. for 10 days.

Twice a week, the pH, the activity of the water (Aw) and total number of aerobic bacteria were evaluated on the samples.

The results are set out in graph 3.

It will be noted the addition of standard potassium lactate increases the shelf life of the product. This increase in shelf life is greater with a high concentration of potassium lactate.

1. A method for increasing the shelf life of a food product based on meat or fish, the method comprising combining the meat-based or fish-based food product with an antimicrobial composition comprising a fermentate obtained by direct fermentation of cane sugar, beet sugar, or starch hydrolysate using bacteria of the Sporolactobacillus, Brevibacillus, or Bacillus genera, or a mixture thereof.

2. The method according to claim 1, wherein the fermentate is obtained by lactic acid fermentation using a non-pathogenic bacterium producing lactic acid, and neutralised with an alkaline hydroxide.

3. The method according to claim 2, wherein the alkaline hydroxide is sodium or potassium hydroxide.

4. The method according to claim 1, wherein the fermentate is obtained using a Bacillus coagulans strain.

5. The method according to claim 1, wherein the fermentate is obtained using a Bacillus smithii strain.

6. The method according to claim 1, wherein the fermentate comprises
a majority portion of alkaline lactate,
a minority portion of one or more salts chosen from the group consisting of acetic, succinic, propionic, malic, fumaric, citric, pyruvic and formic acid salts, wherein the quantity of each does not exceed 5% each;
sugar; and
ethanol.

7. The method according to claim 1, wherein the antimicrobial composition is combined with the food product in an amount of 1% to 5% by weight, based on the weight of the product to be treated.

8. The method of claim 7, wherein the antimicrobial composition is combined with the food product in an amount of 2% to 4.8% by weight, based on the weight of the product to be treated.

9. The method of claim 8, wherein the fermentate comprises 30% to 80% of alkaline lactate.
